(19) United States
(12) Patent Application Publication
(10) Pub. No.: US 2012/0226539 A1
(43) Pub. Date: Sep. 6, 2012

(54) REBATE AND DISCOUNT SYSTEM PARTICULARLY SUITABLE FOR DRIVING PATRONAGE BY MEMBERS OF ORGANIZATION

(76) Inventor: Seth FEUERSTEIN, Woodbridge, CT (US)

(21) Appl. No.: 13/399,025

(22) Filed: Feb. 17, 2012

Related U.S. Application Data
(60) Provisional application No. 61/443,895, filed on Feb. 17, 2011.

(51) Int. Cl. G06Q 30/02

(52) U.S. Cl. 705/14.23; 705/14.27

(57) ABSTRACT

Systems and methods are provided for offering promotional discounts, rebates, and other promotions to improve the utilization of unused inventory and to drive consumer patronage and loyalty. An electronic platform enables businesses and other entities to create and manage customer loyalty and promotional programs. The electronic platform enables businesses and other entities to track levels of patronage by customers in order to offer instant or retroactive rebates on an individual or group basis. The electronic platform further enables an entity to adjust the benefits, discounts, rebates, and promotions based on predetermined behavior, including tracking consumer activity and processing rebates or refunds based on the discounts. The electronic platform provides information systems and networks to track, monitor, and reserve resources. The electronic platform further provides database structures to track purchasing activity and apply varied pricing structures based on volume of usage during set time frames.

### CROSS REFERENCE TO RELATED APPLICATIONS

This Non-provisional application claims the benefit of priority to U.S. Provisional Application Nos. 61/443,895 filed Feb. 17, 2011, the entire contents of which are hereby incorporated by reference.

### FIELD OF THE INVENTION

The present disclosure relates to systems and methods for offering promotional discounts, rebates, and other promotions to improve utilization of unused inventory and drive consumer patronage and loyalty. The invention further relates to an electronic platform that enables businesses to create and manage customer loyalty and promotional programs that enable the tracking of levels of patronage by members of targeted organizations and thereby offer instant and/or retroactive rebates based thereon to all or select members of the targeted organizations.

### BACKGROUND

Customer discounts and rebates have long been known and used to drive consumer activity. Historically, promotional activities have focused heavily upon coupons and sales. Customer loyalty programs, such as frequent flyer programs, frequent diner cards (where a customer, for example, receives a free sandwich after getting a sufficient number of stamps on a small card), retail establish reward clubs, and the like, are a relatively newer form of promotional activity. Loyalty programs are becoming more popular as they commonly form and utilize large databases of consumer activity, thus allowing the entity running the program to track large amounts of valuable consumer activity information, which in turn helps the entity make more informed promotional decisions. For example, loyalty programs for grocery stores track purchases and then mine this information to offer specific coupons to customers at the checkout line.

Current customer loyalty and like promotional systems and methods, however, focus on driving business to individuals and don't effectively market to groups of individuals. Further, such promotional systems are currently focused marketing business activity for a single entity (e.g., a store chain, etc.,) and are often costly to implement. Such current loyalty systems are complicated, but still do not effectively allow various entities to join a community or otherwise be empowered to create and customize their own loyalty programs and associated schedule of benefits (e.g., rebates, discounts, etc.) that are variable upon level of loyalty.

Thus, improved mechanisms for tracking and monitoring of consumer patronage are desirable. In particular, there is a need for a promotional method and related scalable platform that would enable businesses to quickly create and market loyalty program benefits to members of various organizations (e.g., such as the employees of local businesses). Further, there is a need for a system that allows entities to offer and manage loyalty programs that provide increasing level of rewards for further patronage, based upon either increasing levels of individual (e.g., per employee) or group (e.g., all employees of a given company) patronage.

### SUMMARY OF THE DISCLOSURE

The present invention is an electronic platform that enables businesses to create and manage customer loyalty and promotional programs, and methods associated with the use of such a platform. The platform enables an entity running a loyalty program to track levels of patronage by customers, including members of targeted organizations, and thereby offer instant and/or retroactive rebates on an individual or groups basis (e.g., to all or select members of a targeted organization). The platform enables an entity to create and manage a promotional program that offers discounts or other benefits and enables those benefits to adjust based on predetermined behavior, including tracking consumer activity and processing rebates and/or refunds based on those discounts.

Disclosed embodiments of the invention include a module system and other platforms and processes that provide a solution for the allocation of fixed resources for the sale supply and purchase of goods, such as meals in restaurants and rooms in hotels. The invention employs submodules and interrelated and interdependent business processes for the most efficient delivery and most efficient pricing of those limited resources through processes for the incentivized discounting that may be based on volume and/or time. The platforms utilized in embodiments of the inventions provide information systems and networks to track, monitor and reserve resources, and database structures to track purchasing activity and store and apply varied pricing structures based on volume of usage during set time frames. As a result of these methods, sellers, such as restaurants and other service providers, can most efficiently sell and utilize resources.

The system and platform of the present invention allows one or more vendors the opportunity to capture new sales and/or increase sales over a select time period (which is variable and able to be set by the vendor) by offering variable discounts over the assigned period to groups it also can specify by certain variables (such as place of employment). The system also allows purchasers (e.g., members of a loyalty program offered and managed by the platform of the invention) to select which vendors to utilize based on these time constraints and variable discounts. In this fashion, a community of vendors and purchases may be formed, allowing the vendors to craft, manage, and direct promotional programs at interested customers, and in turn allowing interested customers to opt into the program.

Certain embodiments of the platform according to the invention manage a database of customer, vendor, and associated discount program and customer activity information, and have a vendor portal for where they could select a time period (for instance a week, month or other time period) as well as a schedule or other system for varying/increasing discounts based on number of transactions or volume of transactions. Further, the platform could offer a purchaser portal for customers to view current promotions, or even make purchases with certain vendors or make reservations for future activities (e.g., a restaurant reservation). Preferably, the purchaser portal would allow each purchaser to log in and check to see which level of discounts they currently qualify for each participating vendor.

The following description of one particularly preferred embodiment of the invention is intended to depict and exemplify one implementation of the invention and do not therefore limit its scope.

### DETAILED DESCRIPTION OF A PREFERRED EMBODIMENT

One particularly preferred implementation of the present invention may be operated in conjunction with a restaurant reservation system. In the system of the preferred embodiment, restaurants (i.e., the vendor entity running the program) that desire to increase the number of meals that certain customers eat therein offer a discount. The discount may be unrestricted (offered to any member of the public who wants to join a loyalty program) or restricted to certain members of the public (e.g., employees of a local company). The platform enables the vendor entity to define discounts are not static, but rather are linked to a timeframe and a schedule of increasing discount. For instance, if a restaurant seeks to increase the number of meals customers eat there they offer a discount based on the number of meals eaten there by a customer (or all customers being a member of the same group) in a given month. If the customer eats there once that month, there is no discount. At the second meal that month, a discount of X is offered. At three times, the discount may be defined by the restaurant as Y (a larger amount than X, such as some multiple of X). At the fourth meal that month, the discount becomes Z (a larger amount than Y). The restaurant can set a cap on the discount, for instance at 30%. Customers, on the other hand, particularly those who eat at restaurants and desire a good deal, can choose to join the loyalty program.

Preferably, the loyalty program may be operated in conjunction with an online reservation program, such as that offered commercially by OpenTable. In such situations, reservation program user IDs can be linked with IDs (and data) for purchaser members of the discount loyalty program of the present invention. Thus, loyalty program purchaser members, when they actually dine, do not need to present a reward card or otherwise request “credit” for their dining as it would be automatically credited. Further, such integration could allow for accumulated discounts to be accumulated in real time and applied automatically by the restaurant with the check.

Another feature of the new system is that a restaurant can select other restaurants to “pool” the volume numbers and offer more selections to count toward the discount. For instance, a restaurant group may have several locations and can entice users to frequent each of them by pooling the number of visits through each of them. Preferably, this preferred embodiment of the invention permits multiple vendors to offer competing discounts, or optionally to pool discounts to the same group of customers. In other words, several otherwise unaffiliated multiple restaurants can agree to permit loyalty program members to earn increasingly higher discounts at the multiple restaurants by dining at any one of those restaurants within a given time period. Loyalty program members can be notified as discounts are offered or changed (e.g., such as by weekly emails), and they can then make informed decisions and select based on the discounts offered. In this manner, to drive traffic aggressively, vendors can make special offers to potential customers such as “50% off if you dine five times this week”.

In one particularly preferred embodiment of the invention, the platform permits each vendor restaurant to refund the discount to the Customer at the end of the month. In another, the system handles the payment and holds the potential rebates and takes care of refunds at the end of the month. In another version, the customers do not pay their entire bill until the end of the month and the disbursement is already reduced.

By way of illustration, in one iteration of the system as used by a restaurant, the management of the restaurant would select a month. During that month any employer with a tag to recognize them (either a loyalty program account, employer ID, system ID, utilization of their account to make a reservation via a reservation service like OpenTable, etc.) would receive a rebate at the end of the period. The size of the rebate would vary depending on the incentive structure. For instance a restaurant might offer a 2% rebate for eating there twice in a month, 3% for 3 times, 5% for 5 times, 10% for ten times, 20% for twenty times, etc. They could vary the number of events of usage as well as the total discount based on those. The restaurant, after deciding how to structure its promotion, would be able to log into the platform via the vendor portal and utilize provided online forms to define the length of promotion, eligible purchasers, and schedule of rebates.

A user of the services, such as an employer whose employees often entertain clients, could choose to encourage employees to utilize select vendors such as restaurants based on these incentives and/or discounts. For instance, a law firm might choose to entertain clients at a small group of restaurants in a given month in order to be most cost effective.

1. A platform for permitting one or more vendors to create promotional programs that provide varying discounts based upon purchase frequency and time, said platform including a database system for storing purchaser information, discount program definitions, and tracking discounts based on volume of usage by each purchaser, and software enabling a vendor to define said definitions by setting the structure of the time period over which volume is calculated and defining discount levels associated therewith.

2. The platform of claim 1, wherein the individual purchases may be indirectly associated with an entity receiving the discount or rebate.

3. The platform of claim 1, wherein individual purchasers are directly associated with an entity receiving the discount or rebate

4. The platform of claim 1, wherein a vendor can set discounting levels using an online portal.

5. The platform of claim 1, wherein purchasers can utilize a web portal managed by the platform to make reservations at participating vendors.

6. The platform of claim 1, wherein the database track usages and expected discounts and provides reports to vendors regarding the same.

7. The platform of claim 1, wherein email reminders and/or announcements are sent to encourage reaching certain discounts or rebates.

8. The platform of claim 1, wherein a purchaser portal allows purchasers to log in and view promotional offerings.

9. The platform of claim 1, wherein the platform calculates discounts in real time.
